(19) United States
(12) Patent Application Publication
(10) Pub. No.: US 2011/0199780 A1
(43) Pub. Date: Aug. 18, 2011

(54) ILLUMINATION DEVICE CONFIGURED TO MIX LIGHT FROM A FIRST AND A SECOND LIGHT EMITTING DEVICE

(75) Inventors: Martin J. J. Jak, Eindhoven (NL); Ramon P. Van Gorkom, Eindhoven (NL); Gilbert M. Verbeek, Breugel (NL)

(73) Assignee: KONINKLIJKE PHILIPS ELECTRONICS N.V., EINDHOVEN (NL)

(21) Appl. No.: 13/124,148

(22) PCT Filed: Oct. 9, 2009
(86) PCT No.: PCT/IB2009/054442

§ 371 Date: Apr. 14, 2011

(30) Foreign Application Priority Data
Oct. 16, 2008 (EP) 08166807.1

(51) Int. Cl. G02B 6/00

(52) U.S. Cl. 362/551

(57) ABSTRACT

An illumination device (100) comprising a light-guide (104) configured to guide light from an entrance end (108) to an exit end (110); a partially transparent partition (106) arranged in said light-guide and configured such that light of a given wave length incident thereupon is partially transmitted and partially reflected, wherein said partially transparent partition (106) extends along at least a portion of said light guide, and divides that portion of the light-guide in first (104a) and second (104b) separated regions; a first light emitting device (102) arranged to incouple light to at least said first region (104a) ; and a second light emitting device (103) arranged to incouple light to at least said second region (104b).

An advantage is that uniform illumination can be achieved also in applications where the length of the illumination device is restricted, e.g. for a retro-fit unit.

### TECHNICAL FIELD

The present invention relates to an illumination device comprising a light-guide to enable uniform illumination. In particular, the present invention relates to an illumination device where a light-guide is used to mix light from a first and a second light emitting device.

### BACKGROUND OF THE INVENTION

Today, small point light sources such as light emitting diodes (LEDs) are widely used in illumination devices. In some applications it may be required that light from a plurality of LEDs are properly mixed. An example would be an illumination device for color variable lighting. Such a device is typically based on a plurality of differently colored LEDs, and the light from the individual LEDs are typically mixed in a mixing rod to achieve a desired illumination effect. The color can be set by varying the current through the different LEDs.

U.S. Pat. No. 6,728,448 discloses a light mixing rod having a quadrangular cross-section, which guides light from an inlet area to an outlet area. The mixing rod enables a surface to be uniformly illuminated. The light mixing rod may further comprise a reflectively coated partition which extends a predetermined distance from the inlet to the outlet area resulting in an inhomogenization of the luminance distribution in the outlet area.

However, a limitation is that proper mixing of light typically requires that the mixing rod has a large length over thickness ratio. Thus, the mixing of light can be increased by reducing the thickness of the light-guide. However, this will reduce the incoupling efficiency and thereby the overall efficiency of the illumination device. An alternative would be to increase the length of the light-guide. However, in many applications (such as e.g. in a retro-fit unit for replacing an incandescent light bulb with a LED-based light bulb) the length allowed is restricted. Thus, there is a need for a compact and efficient illumination device which enables a more uniform illumination.

### SUMMARY OF THE INVENTION

In view of the above, an object of the invention is to solve or at least reduce the problems discussed above. In particular, an object is to provide an illumination device which is compact, efficient and enables a more uniform illumination.

According to a first aspect of the invention, there is provided an illumination device comprising: a light-guide configured to guide light from an entrance end to an exit end; a partially transparent partition arranged in the light-guide and configured such that light of a given wave length incident thereupon is partially transmitted and partially reflected, wherein the partially transparent partition extends along at least a portion of the light guide, and divides that portion of the light-guide in first and second separated regions; a first light emitting device arranged to incouple light to at least the first region, and a second light emitting device arranged to incouple light to at least the second region.

The present invention is based on the understanding that by arranging a partially transparent partition in the light-guide, the average number of reflections can be increased for light propagating in the light-guide whereas the light still mixes over the entire cross-section of the light-guide. Thus, enhanced mixing of light can be achieved for a given length over thickness ratio of the light-guide, or put differently, enhanced mixing of light can be achieved for a given length of a light-guide with maintained efficiency.

An advantage is that uniform illumination can be achieved also in applications where the length of the illumination device is restricted, e.g. for a retro-fit unit. This improvement can be achieved in a cost-efficient way as the only modification required is the partially transparent partition. Furthermore, the arrangement preserves etendue so that the illumination device can be used to create a collimated beam.

As the partially transparent partition is configured such that light of a given wave length incident thereupon is partially transmitted and partially reflected, it should be understood that light of a certain color (e.g. blue light) may be both transmitted and reflected by the partially transparent partition. This is different from a conventional color filter which is used to selectively pass light of a small range of colors while reflecting other colors.

WO2008/017968 discloses an illumination device comprising a semiconductor light source for generating light, and a primary optical system for feeding the light to a reflector, which is provided for radiating the light and for achieving a desired radiation pattern. The primary optical system comprises a light-guide with a mirrored end-face and an out-coupling structure for directing light into the reflector. The mirrored end-face optically folds the light guide, effectively extending the length over which the light is homogenized inside the light guide, while making more economical use of the space inside the reflector.

Although the illumination device disclosed in WO2008/017968 enhances the uniformity of the illumination, the illumination device according to the present invention enables a more compact and less complex solution. Furthermore, unlike the present invention, the optically folded light-guide in WO2008/017968 results in an illumination device having a reversed outcoupling direction compared to an illumination device utilizing a conventional light-guide.

The partially transparent partition may extend along the entire light-guide. As the partially transparent partition extends through a larger portion of the light-guide the average number of reflections of light propagating in the light-guide can be increased. This means that as the partially transparent partition extends along the entire light-guide the mixing of light can be maximized.

The partially transparent partition is typically configured to provide a good trade-off between a large number of reflections and mixing light over the entire cross-section.

For example, in an embodiment where a single partially transparent partition is used, the portion of light being transmitted may preferably be essentially equal to the portion of light being reflected. However, for embodiments where two or more partially transparent partitions are arranged in a way that a light beam typically needs to pass through more than one partially transparent partition as it travels from one side wall of the light-guide to another side wall of the light-guide, each partition may preferable be configured such that that the portion of light that is transmitted is larger than the portion of light that is reflected.

According to an embodiment, the partially transparent partition is provided with a metallic coating having a thickness configured such that a portion of an incident light beam is transmitted and a portion thereof is reflected. (Assuming that loss due to absorption would be negligible, any remaining light that is not transmitted would be reflected) The metallic coating may be e.g. silver or aluminium, with a thickness that is thin enough so that part of the light is transmitted and part of the light is reflected. As a light beam incident upon the partially transparent partition is split, the number of light-beams is increased. This further enhances uniformity of the illumination. The reflection-transmission ratio can be configured by adapting the thickness of the coating.

According to an alternative embodiment, the partially transparent partition comprises at least one transmissive region and at least one reflective region, wherein a ratio between an area of the at least one transmissive region and an area of the at least one reflective region is configured such that a predetermined portion of light incident upon the partially transparent partition is transmitted.

A transmissive region should here be understood as a region where essentially all light is transmitted, whereas a reflective region here should be understood as a region where essentially all light is reflected. By adapting the ratio between the total area of the transmissive regions and the total area of the reflective regions the ratio between transmitted and reflected light for the partially transparent partition can be adjusted. For example, to achieve a partially transparent partition where half of the light is transmitted and half is reflected, the total area of the transmissive regions should correspond to the total area of the reflective regions. This has the advantage that one does not need precise control of the layer thickness to tune the ratio of transmission and reflection.

The partially transparent partition may be arranged along the (longitudinal) centre axis of the light-guide. This results in a symmetry which has been found to result in a particularly good mixing of light thereby providing a more uniform light output.

The entrance end (and/or the exit end) may be configured to modify the angular distribution of the light in the light-guide to reduce the portion of light that passes through the light-guide without striking the partially transparent partition. This can be achieved, for example, by a prismatic structure having one or more facets or a set of prismatic grooves. By avoiding light-beams parallel to the length direction of the light-guide (which never hit the partially transparent partition) mixing of light can be further enhanced.

The light-guide may be configured to guide light by means of total internal reflection (TIR). This avoids possible absorption losses at the reflecting side walls, and hence improves the efficiency.

The light-guide may be a hollow light-guide formed by a set of reflective side walls. This typically enables a wider range of propagation angles than for light guided by

TIR, and avoids any losses due to Fresnel reflection on the entrance and exit ends of the light-guide.

The first light emitting device may emit light of a first color and the second light emitting device may emit light of a second color different from said first color. This enables color variable lighting where the color can be set simply by varying the current through the different light emitting devices.

A plurality of partially transparent partitions may be arranged in the light-guide to further enhance mixing of light.

The illumination device may further comprise a collimator arranged at the exit end of the light-guide so that the illumination device provides a collimated beam.

The light-guide may have a hexagonal cross-section. This has been found to enable particularly good mixing of light.

The illumination device may be used in a luminaire, i.e. a device intended to illuminate an object or a surrounding.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1a-b schematically illustrates an illumination device according to a preferred embodiment of the invention.

FIG. 2a-c schematically illustrates the principle of a light mixing rod.

FIG. 3a-b schematically illustrates how a partially transparent partition further enhances mixing of light.

FIG. 4a-b schematically illustrates two examples of partially transparent partitions.

FIG. 5a-c schematically illustrates a light-guide having an entrance end provided with facets.

FIG. 6 schematically illustrates a light-guide having an exit end provided with facets.

FIG. 7a-b schematically illustrates another embodiment of an illumination device according to the invention.

FIG. 8 schematically illustrates yet another embodiment.

FIG. 9a-c schematically illustrates three examples of a light-guide provided with a plurality of partially transparent partitions.

### DETAILED DESCRIPTION OF PREFERRED EMBODIMENTS

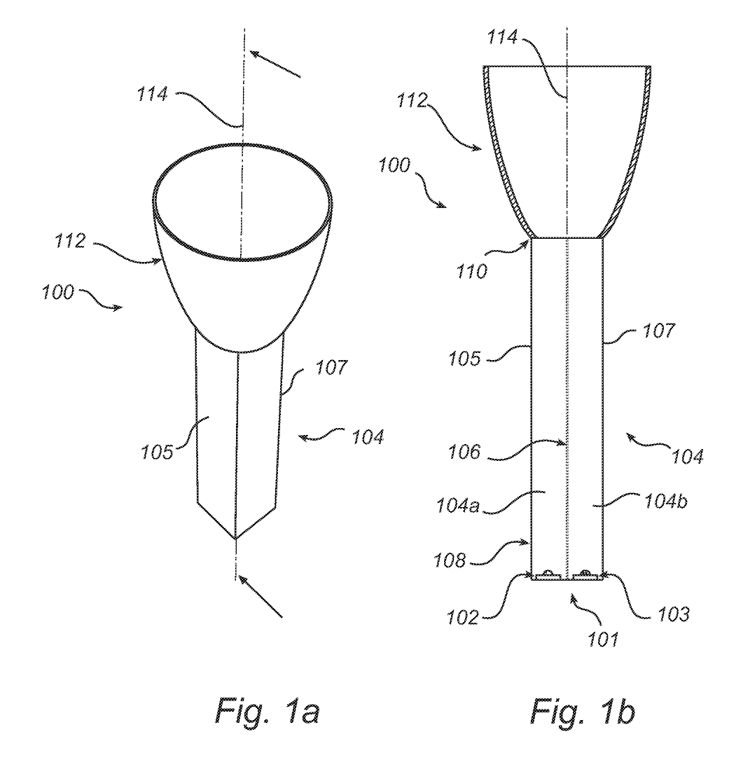

FIG. 1a-b schematically illustrates an illumination device 100 according to a preferred embodiment of the invention. The illumination device 100 comprises a light source 101, a mixing rod in the form a light-guide 104, and a partially transparent partition 106 dividing the light-guide in first 104a and second 104b separated regions. Furthermore, the illumination device here has a collimator 112.

The light-guide 104 is here a solid rod extending from an entrance end 108 to an exit end 110. The cross-section of the depicted light guide 104 is rectangular and has a constant size throughout the light-guide. However, other cross-sectional shapes may be used (e.g. circular, or hexagonal), and the size of the cross-section may vary along the light-guide (e.g. the light-guide may be tapered in any direction). Further, the solid light-guide 104 is made from a material which is transparent to the light emitted by the light source 101, and has a refractive index that enables Total Internal Reflection. Examples of suitable materials are PMMA (polymethyl methacrylate) or glass, whereas the medium surrounding the light-guide typically may be air.

The light source 101 is arranged to incouple light at the entrance end 108 of the light-guide 104. The light source 101 typically comprises a set of small point light sources, here being a red LED (light emitting diode) 102 and a blue LED 103. It should be understood that the two LEDs and their colors are chosen for illustrative purpose only, and that the invention is equally applicable to a larger number of LEDs, and to LEDs of other colors. The invention may also be used to mix light from LEDs having the same colors. Furthermore, other types of small point light sources may used such as, for example, lasers or OLEDs (organic LEDs).

Examples of typical combinations of LEDs are “warm white” and “cool white” (two LEDs), or red-green-blue (three LEDs), or red, green, blue, white (four LEDs).

However, depending on the required power level of the light source, and the power per LED package more LEDs may be used, or for example if one of the LEDs (e.g. the red one) is less efficient than the green and blue ones, there may for example be two red LEDs and one blue LED and one green LED.

Furthermore, the exit end 110 of the light-guide 104 is arranged in the collimator 112 so that the illumination device 100 generates a collimated beam. The exit end 110 of the light guide 104 can preferably be located at the focal point of the collimator 112 to provide efficient illumination.

The partially transparent partition 106 arranged inside the light-guide 104, is here arranged along the centre axis 114 of the light guide 104 and extends from the entrance end 108 to the exit end 110. Although, the partially transparent partition 106 here extends throughout the light-guide 104, this is may vary depending on the application and the desired illumination effect. Thus, it is possible to have a partially transparent partition that extends throughout a portion (e.g. half or two thirds) of the light-guide, or to have a partially transparent partition which is longer than the light-guide and extends into the collimator.

Here the partially transparent partition 106 is a metallic coating such as e.g. silver or aluminium. The partially transparent partition 106 can be achieved e.g. by dividing the light guide 104 into two pieces by a cut along the centre axis 114, coating one of the two pieces with metal (i.e. at the surface resulting from the cut), and reassemble the light-guide 104 by gluing the other part to the metal coating with an index matching glue (i.e. a glue with a refractive index that match the refractive index of the light-guide). The metallic coating that makes up the partially transparent partition 106 should be sufficiently thin so that, as a light beam strikes the partially transparent partition 106, part of the light is transmitted and part of the light is reflected. By adjusting the thickness of the metallic coating the ratio between reflected and transmitted light can be adjusted. For example, for a light beam incident at a 60 degree angle from the normal on a 5 nm layer of aluminium sandwiched between glass pieces, roughly equal amounts of light are reflected and transmitted.

The light-guide may also be a hollow light-guide (e.g. an air cavity bounded by reflective walls, such as mirrors). If so, the metallic layer is typically supported by a transparent substrate (e.g. made of glass). In order to maintain symmetry the transparent substrate may preferably be coated on both sides.

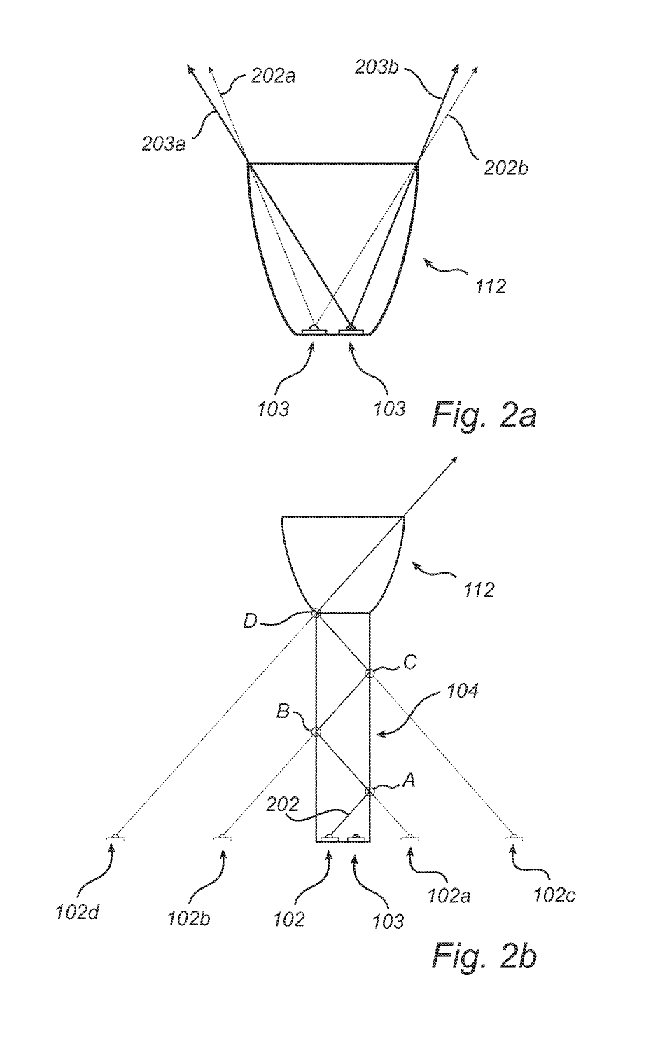

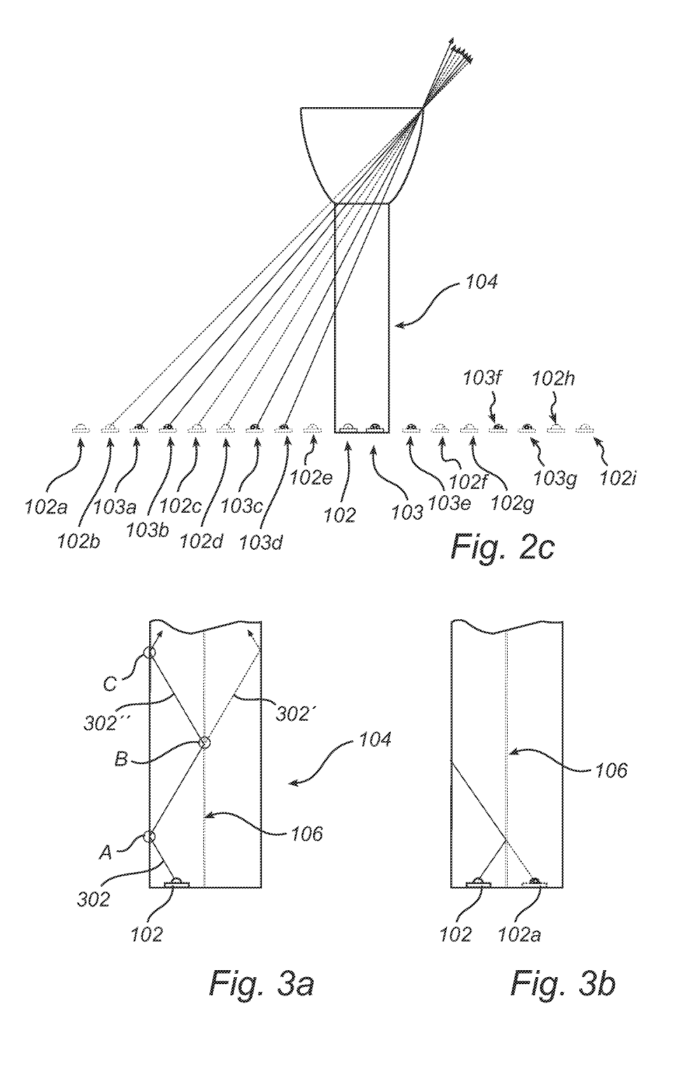

The effect of the partially transparent partition will be further discussed below in relation to FIG. 3. However, to provide a better understanding of the invention, the effect of a conventional mixing rod will first be briefly illustrated with reference to FIG. 2a-c.

FIG. 2a schematically illustrates an illumination device where a red LED 102 and a blue LED 103 is arranged in a collimator 112. As illustrated by light beams 202a-b, 203a-b the angular distributions of the two colors are not the same for such an illumination device and the resulting illumination will not have uniform color.

To improve the color uniformity, a mixing rod in the form of a light-guide 104 is arranged between the LEDs 102,103 and the collimator 112 as schematically illustrated in FIG. 2b. As light emanating from the LEDs 102,103 is guided through the light-guide 104 by Total Internal Reflection (TIR) a “virtual image” of an LED is created by each reflection. This can be understood by following a light-beam on its way through the light-guide 104, from the entrance end to the exit end. Referring to FIG. 2b, a light beam 202 emanating from the red LED 102 is first reflected at the surface of the light-guide at point A, creating virtual LED 102a. The light beam 202 is then reflected at point B resulting in virtual LED 102b, at point C resulting in virtual LED 102c and at point D resulting in virtual LED 102d. Thus, after many reflections the light from red LED 102 seems to originate from many sources. Naturally, the same principle applies to light emanating from the blue LED 103.

Thus, in a typical application, the light outcoupled from the light-guide 104 is perceived as originating from many sources as illustrated in FIG. 2c, where red light is perceived to originate from the red LED 102, and a set of the red virtual LEDs 102a-i, and blue light is perceived to originate from the blue LED 103, and a set of the blue virtual LEDs 103a-g. As the light outcoupled from the light-guide 104 is perceived as originating from many sources the color uniformity is improved.

Below, with reference to FIG. 3a-b, it will be described how the partially transparent partition (suggested by the present invention) further improves mixing of light.

In FIG. 3a, a light-beam 302 emanating from the red LED 102, is reflected at the surface of the light-guide at point A. The light-beam 302 then strikes the partially transparent partition 106 at point B, where a portion 302′ of the light-beam is transmitted and a portion 302″ of the light beam is reflected. Thus, in the illustrated example a portion 302″ of the light-beam will be reflected three times (at point A, B, and C), instead of twice as would be the case if there where no partially transparent partition. At the same time light is mixed over the entire cross-section of the light-guide 104 as illustrated by portion 302′ of the light beam. Furthermore, as the light beam is split at point B, the number of light-beams are increased, further improving the uniformity.

Another effect of the partially transparent partition 106 is illustrated in FIG. 3b. Here, a virtual image 102a of the red LED 102 is created as light is reflected on the partially transparent partition 106. As the partially transparent partition 106 is arranged along the centre axis of the light-guide 104, this virtual red LED 102a is symmetrically positioned inside the light guide 104 on the other side of the partition 106. Thus, for an arrangement comprising a red and a blue LED arranged on different sides of the partially transparent partition (such as in the arrangement described in relation to FIG. 1) a virtual image of the red LED is created by the partially transparent partition, which falls directly on top of the blue LED and vice versa. This may further enhance the color mixing.

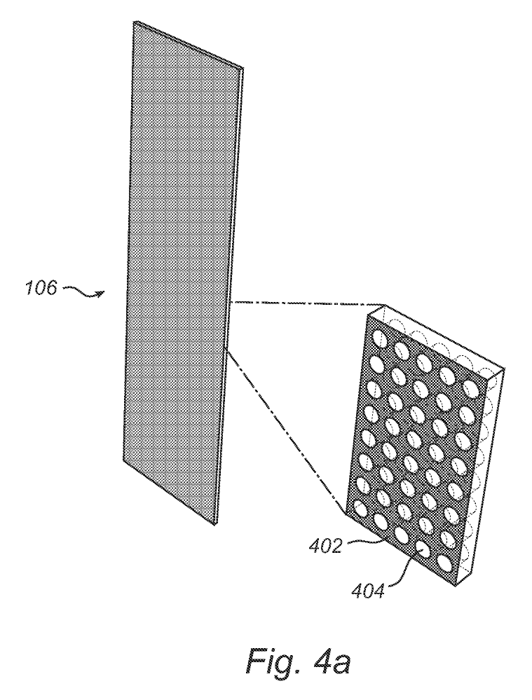

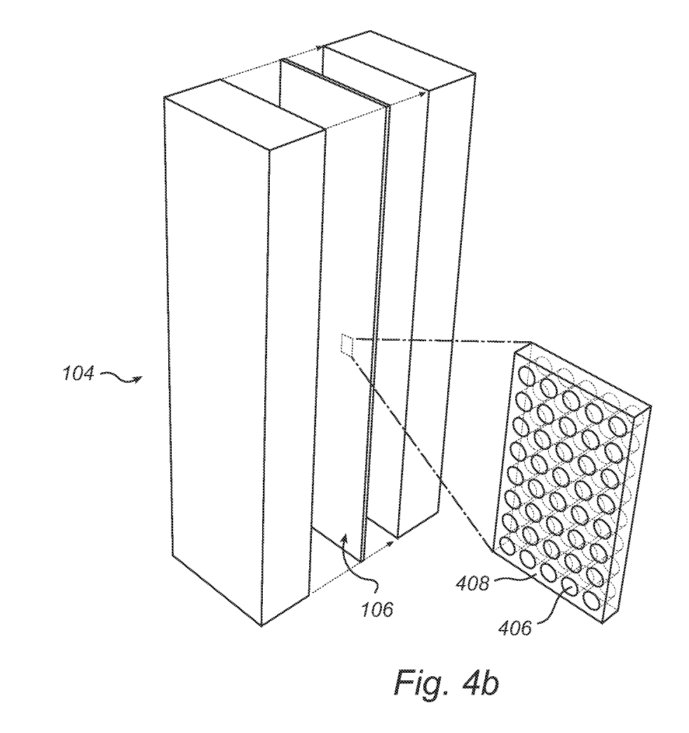

FIG. 4a schematically illustrates an alternative embodiment of a partially transparent partition. Here, instead of tuning the reflection/transmission ratio with the layer thickness of the metallic coating, the partition has a thick metallic layer 402 (reflecting light) with holes inside 404 (transmitting light). Thus, as a light beam strikes the partially transparent partition, it is either reflected (if it strikes the reflective portion) or transmitted (if it strikes the transmissive portion). The area ratio between the holes 404 and the metallic coating 402 determines the transmission-reflection ratio. Thus, if the total area of the holes has the same area as the region covered with metallic coating, a 50-50 ratio between transmission and reflection can be obtained. Preferably the holes are substantially smaller than the width of the light guide, e.g. an order of magnitude smaller. A lower limit is the manufacturability. Typical diameters may be in the range tens of microns to a few millimeter. Furthermore, the shape of the reflective and transmissive regions may vary.

As the metallic coating typically is associated with some absorptions it may be preferable to use a dieelectric layer, or more typically a stack of dielectric layers, for each reflective region. The refractive index and thickness of these layers are preferably chosen such that the angle and wave length dependence of the transmission- reflection ratio is minimized.

For a solid light-guide a partially transparent partition may also be achieved by dividing the light-guide 104 (made of e.g. PMMA), and gluing the two halves of the light-guide together with an index matching glue leaving holes inside, filled with air as illustrated in FIG. 4b. For a region where index matching glue is used there will be good transmission, and essentially no reflection, whereas for a region where the two halves of the light-guide are separated by air, there will be total internal reflection, and essentially no transmission. The layer is typically made as thin as possible, to prevent rays hitting the sides of an air region as this could lead to light being extracted from the light-guide. The area ratio of the air holes 406 and the region 408 provided with index matching glue determines the transmission and reflection ratios.

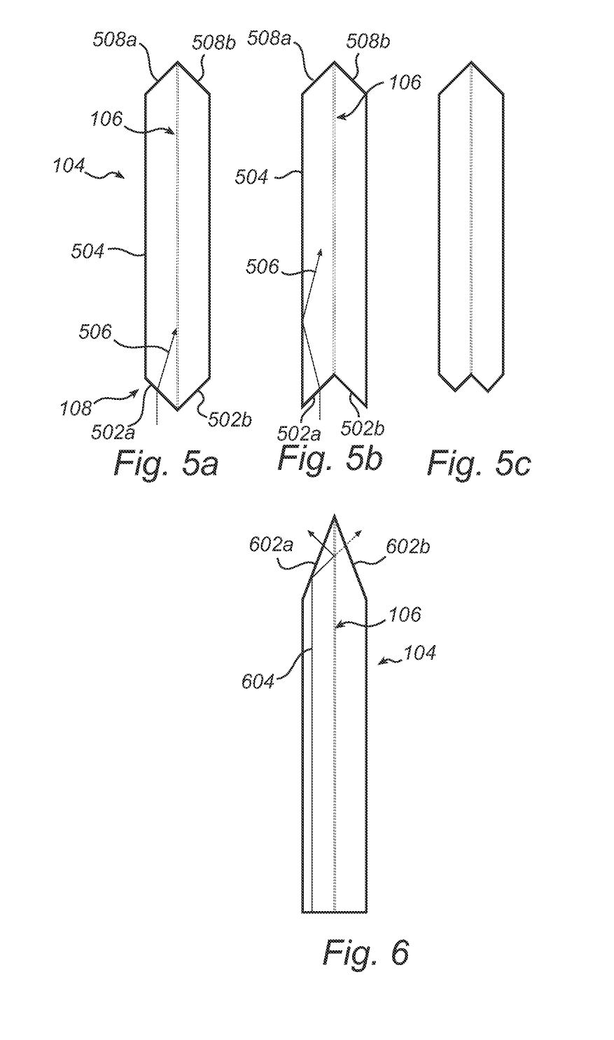

FIG. 5a is an schematic illustration of a light-guide 104 having an entrance end 108 provided with facets 502a-b. As illustrated, the facets 502a-b bends a light-beam 506 towards the partially transparent partition. As the arrangement widens the angular distribution of the light inside the light-guide, the portion of light beams propagating along or close to the length direction of the light-guide (e.g. parallel to the side-surfaces 504 and the partially transparent partition 106) can be reduced, thereby enhancing mixing of light.

FIG. 5b shows an alternative embodiment, where the facets 502a-b bends a light-beam outwards toward the side-surface 504, but via reflection on the side-surface 504 this also results in that the light-beam 506 strikes the partially transparent partition 106.

As schematically illustrated in FIG. 5c, the entrance end may have more than two facets.

As the facets widen the angular distribution two undesirable effects may occur. First, light may escape from the light-guide. This can be overcome by providing a reflective surface, such as a mirror, at the side-walls of the light-guide. Second, some light may not escape the exit surface due to total internal reflection. As illustrated in FIG. 5a-b, facets 508a-b on the exit end of the light-guide may improve this.

It is recognized by a person skilled in the art that there are alternative ways to increase the angular distribution such as, for example, by using a prismatic structure with grooves. The angular distribution may also be changed, for example, by scattering from particles or surface roughness, by holographic diffusers, or by diffraction on a grating. FIG. 6 schematically illustrates another embodiment, where a light-guide 104 is provided with facets 602a-b at the exit end of the light-guide. Due to the tapered exit a light-beam 604 along the length direction is re-directed towards the partially transparent partition 106.

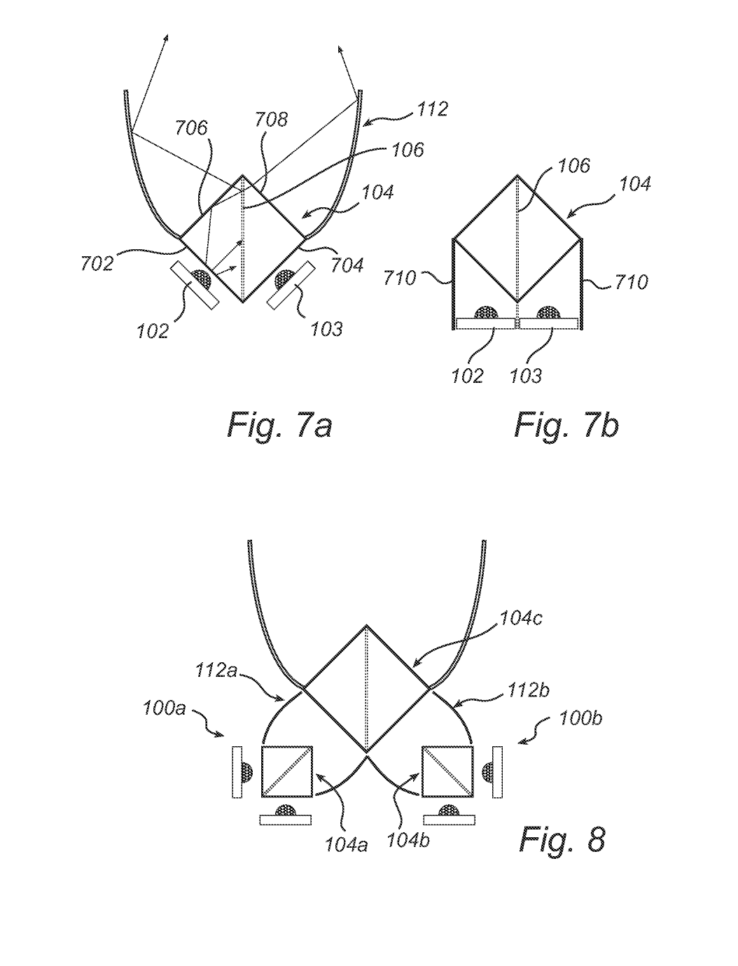

FIG. 7 schematically illustrates an embodiment where the illumination device has a cube-shaped light-guide 104 with a partially transparent partition 106 arranged along the diagonal. The cube-shaped light-guide is arranged on its ridge, and a red LED 102, and a blue LED 103 are provided to incouple light at an entrance end formed by a first 702 and a second side 704 of the cube. Here, the red LED 102 incouples light through the first side 702, whereas the blue LED 203 incouples light through the second side 704. Light is outcoupled at an exit end of the light-guide formed by a third 706 and a fourth 708 side of the cube. Thus, the light-guide is composed entirely of entrance 702,704 and exit 706,708 facets.

In this embodiment essentially all light-beams hit the partially transparent partition 106, and exit at one of the two facets 706,708 opposing the LEDs (apart from light-beams that are reflected by Fresnel reflection). The cube-shaped light-guide 104 is here used in combination with a collimator 112. The LEDs 102,103 can also be mounted on a single flat substrate as illustrated in FIG. 7b, by providing additional mirrors 710 to guide the light emanating from the LEDs 102-103 to the light-guide.

According to an alternative embodiment a cube-shaped light-guide can be arranged on a corner point in combination with three LEDs on the sides (i.e. light can be incoupled at three sides).

Another possible extension to three or more LEDs is the use of multiple cube-shaped light-guides, where the exit of one cube-shaped light-guide can be positioned at the entrance of another cube-shaped light-guide. An example thereof is illustrated in FIG. 8. Here the output of collimators 112a-b of two illumination devices 100a-b are used as an input for a cube shaped light-guide 104c.

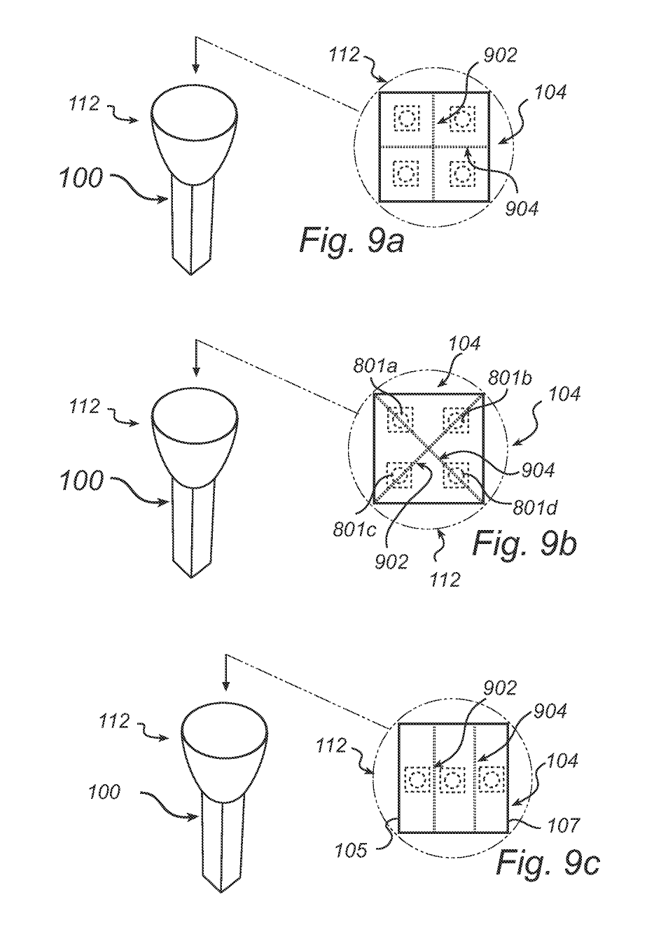

According to an alternative embodiment of the invention a plurality of partially transparent partitions may be utilized in the light-guide. Three examples thereof are illustrated in FIG. 9a-c each showing a cross-section of a light-guide 104 having a first partially transparent partition 902 and a second partially transparent partition 904. It is noted that, in the embodiment illustrated in FIG. 9c, a light beam needs to pass through two partially transparent partitions 802, 804 on its way from side wall 105 to side wall 107. Thus, it may be preferable if the portion of light transmitted is larger than the portion of light reflected. For example, approximately two thirds of the light incident upon the partially transparent partition may be transmitted.

Moreover, it is noted that by arranging four light emitting devices 801a-d in the four corner quadrants in the embodiment in FIG. 9c, each light emitting device 801a-d will be placed right underneath one of the partially transparent partitions 802,804 so that both sides of the partially transparent partition is illuminated.

The invention has mainly been described above with reference to a few embodiments. However, as is readily appreciated by a person skilled in the art, other embodiments than the ones disclosed above are equally possible within the scope of the invention, as defined by the appended claims. For example, the partition is not necessarily arranged along the centre axis. Moreover, a light emitting device might be placed underneath the partially transparent partition so that both sides are illuminated.

1. An illumination device comprising:
a light-guide configured to guide light from an entrance end to an exit end;
a partially transparent partition arranged in said light-guide and configured such that light of a given wave length incident thereupon is partially transmitted and partially reflected, wherein said partially transparent partition extends along at least a portion of said light guide, and divides that portion of the light-guide in first and second separated regions;
a first light emitting device arranged to incouple light to at least said first region; and
a second light emitting device arranged to incouple light to at least said second region.

2. An illumination device according to claim 1, wherein the partially transparent partition extends from said entrance end.

3. An illumination device according to claim 1, wherein the partially transparent partition extends along the entire light-guide.

4. An illumination device according to claim 1, wherein the partially transparent partition is provided with a metallic coating having a thickness configured such that a portion of an incident light beam is transmitted and a portion thereof is reflected.

5. An illumination device according to claim 1, wherein the partially transparent partition comprises at least one transmissive region and at least one reflective region, wherein a ratio between an area of the at least one transmissive region and an area of the at least one reflective region is configured such that a predetermined portion of light incident upon the partially transparent partition is transmitted.

6. An illumination device according to any one of the preceding claims, wherein the partially transparent partition is arranged along the centre axis of the light-guide.

7. An illumination device according to claim 1 wherein the entrance end is configured to modify the angular distribution of the light in the light-guide to reduce the portion of light that pass through the light-guide without striking the partitially transparent partition.

8. An illumination device according to claim 1 wherein the light-guide is configured to guide light by means of total internal reflection (TIR).

9. An illumination device according claim 1, wherein said light-guide is a hollow light-guide formed by a set of reflective side walls.

10. An illumination device according to claim 1 wherein said first light emitting device emits light of a first color and said second light emitting device emits light of a second color different from said first color.

11. An illumination device according to any claim 1, comprising a plurality of partially transparent partitions.

12. An illumination device according to claim 1 further comprising a collimator arranged at the exit end of the light-guide.

13. An illumination device according to claim 1, wherein said light-guide has a hexagonal cross-section.

14. A luminaire comprising an illumination device according to claim 1 and driving electronics arranged to power said first and second light emitting device.
